(19) United States
(12) Patent Application Publication
(10) Pub. No.: US 2005/0018726 A1
(43) Pub. Date: Jan. 27, 2005

(54) Diode laser configuration with a plurality of diode lasers that are electrically connected in series

(75) Inventors: Reinhold Dinger, Glinde (DE); Claus Rudiger Haas, Aachen (DE); Dieter Hoffmann, Simmerath (DE)

Correspondence Address: LERNER AND GREENBERG, PA, P O BOX 2480, HOLLYWOOD, FL, 33022-2480, US

(73) Assignees: Rofin-Sinar Laser GmbH; Fraunhofer-Gesellschaft zur Forderung der Angewandten Forschung e.V.

(21) Appl. No.: 10/924,318

(22) Filed: Aug. 23, 2004

Related U.S. Application Data
(63) Continuation of application No. PCT/EP03/02016, filed on Feb. 27, 2003.

(30) Foreign Application Priority Data
Mar. 2, 2002 (DE) 102 09 374.1

(51) Int. Cl. H01S 3/00; H01S 3/04

(52) U.S. Cl. 372/38.09; 372/36

(57) ABSTRACT

A diode laser array has a plurality of electrically series-connected diode lasers. Each of the diode lasers has a bypass device that is electrically connected in parallel with the laser. The bypass is high-ohmic in normal operation and bypasses the diode laser with low resistance in the case of a diode laser diode defect, that would otherwise lead to high-ohmic interruption of the electric circuit. The bypass configuration is disposed on a cooling and contact element together with the diode laser.

### CROSS-REFERENCE TO RELATED APPLICATION

This is a continuing application, under 35 U.S.C. § 120, of copending international application No. PCT/EP03/02016, filed Feb. 27, 2003, which designated the United States; this application also claims the priority, under 35 U.S.C. § 119, of German patent application No. 102 09 374.1, filed Mar. 2, 2002; the prior applications are herewith incorporated by reference in their entirety.

### BACKGROUND OF THE INVENTION

1. Field of the Invention

The invention lies in the field of diode lasers and pertains, more specifically, to a diode laser configuration having a plurality of electrically series-connected diode lasers.

High power diode lasers have a large number of possible fields of application. These include, inter alia, pumping solid state lasers or material processing. A high power diode laser contains, as the active laser element, a rectangular semiconductor structure, the diode laser bar, which comprises a plurality of single emitters that are disposed next to one another and are electrically connected in parallel. Such a diode laser bar is typically approximately 10 mm long, 0.3-2.0 mm wide and 0.1-0.15 mm high. The laser light generated at the pn-junctions exists on the longitudinal side of the diode laser bar. The diode laser bar is arranged between a baseplate and a top plate, which serve both for making electrical contact and for cooling. The component comprising diode laser bars, electrical contacts and cooling is called a diode laser. The typical optical output powers of such a diode laser range from approximately 1 W to several 100 W, depending on design and mode of operation.

To increase the output power further, a plurality of diode lasers are arranged geometrically next to one another (=horizontal stack) and/or above one another (=vertical stack).

Such a stack typically contains between approximately 2 and several 100 diode lasers electrically connected in series. During operation of the stack, one or more of the diode lasers arranged in the stack may fail, for example as a result of spontaneous destruction of the diode laser bar or as a result of failure of the electrical contact made with the diode laser bar. Such a high-resistance fault in a single diode laser means that the current flowing through the series circuit in the stack is interrupted, so that the entire stack fails. Consequently, failure of a single diode laser results in the entire stack needing to be replaced. This can cause the entire laser system to stop operating, which may be associated with considerable financial loss. Such operating failure could, in principle, be avoided by redundant arrangements with parallel-connected diode laser stacks. This would result in significantly higher costs for the laser source, however.

### SUMMARY OF THE INVENTION

It is accordingly an object of the invention to provide a diode laser configuration, which overcomes the above-mentioned disadvantages of the heretofore-known devices and methods of this general type and which has a plurality of series-connected diode lasers and which can continue to be operated even when a single diode laser fails.

With the foregoing and other objects in view there is provided, in accordance with the invention, a diode laser configuration, comprising:
a plurality of diode lasers electrically connected in series, each of said diode lasers including a diode laser bar disposed on a cooling and contact element;
a plurality of bypass configurations each electrically connected in parallel with a respective said diode laser, said bypass configurations having a high resistance in normal operation and providing a low-resistance bridge for the respective said diode laser connected in parallel therewith in an event of a high-resistance fault in the respective said diode laser, said bypass configuration being commonly disposed on said cooling and contact element of the respective said diode laser connected in parallel therewith.

In other words, the invention achieves the above objects with a diode laser configuration in which each of the diode lasers, which are electrically connected in series, has at least one bypass configuration electrically connected in parallel with it which has a high resistance in normal operation and provides a low-resistance bridge for the respective diode laser in the event of a high-resistance fault, there is the assurance, despite failure of a diode laser, that the flow of current through the other diode lasers connected in series with the diode laser which has failed will not be interrupted. The entire stack can continue to be operated with just a negligible reduction in power, which means that any replacement or repair work which is necessary can be moved to planned down times for the laser system which is equipped with this diode laser configuration.

Optionally, the diode laser stack may be equipped with redundant diode lasers or a power reserve may be held, so that there is no drop below the planned rated power of the diode laser stack in the event of individual diode lasers failing.

In this context, the terms “low resistance” and “high resistance” are to be understood as follows: the resistance of the bypass configuration in normal operation is high enough for the power loss from the bypass configuration to be lower than the power consumption of the diode laser. Preferably, the power loss is less than 1/10 of the power consumption. In the case of bridging, the resistance of the bypass configuration falls to a value which does not significantly exceed the order of magnitude of the resistance of the diode laser in normal operation, and is preferably much lower than this. In this case, it should be noted that the flow of current both in the diode laser and in the bypass configuration is influenced by the nonreactive resistance and by a characteristic voltage threshold which is influenced by the diffusion voltage (in the case of a diode characteristic) or by the trigger or threshold value voltage (in the case of thyristors or transistors).

In another preferred refinement, a self-switching bypass configuration is provided, the term self-switching needing to be understood in the sense that the bypass configuration inevitably changes to low resistance without external control when the voltage across the diode laser exceeds a threshold value.

The self-switching bypass configuration provided is preferably a diode or a circuit comprising a plurality of diodes which is at high resistance for a voltage in the operating range of the diode laser.

In one advantageous refinement of the invention, a self-switching bypass configuration is provided which contains a thyristor, or a circuit made up of a plurality of thyristors, as the controllable switching element. The thyristor is a controllable switch having three connections: the anode and the cathode are connected in a similar manner to a diode. The thyristor turns on when the third connection, which is used for control, has an electrical voltage applied to it which is higher than a threshold voltage specific to the component. This voltage is advantageously tapped off at the anode of the thyristor as a result of the increase in voltage when there is a high-resistance diode laser fault. The advantage of this arrangement over a simple diode as the bypass configuration is its significantly lower power loss. Since a bypass configuration made up of diodes always has a higher power loss than the bridged diode laser during rated operation, the power consumption of the diode laser stack increases after a fault as compared with rated operation. By contrast, the thyristor bypass has a lower power loss than the bridged diode laser, since the operating voltage of the thyristor can fall significantly below the trigger voltage without the thyristor changing to high resistance again. This results in an increased useful life for the bypass, lower cooling complexity and lower power consumption.

It is particularly advantageous if the thyristor reliably triggers as near as possible above the maximum operating voltage of the diode laser. The thyristor's threshold value response which is required for this can be achieved either through suitable design of the thyristor or through additional elements with a defined threshold response, e.g. by using a Zener diode.

Instead of a self-switching bypass configuration with a controllable switching element, it is fundamentally also possible for the control signal which is required for switching the controllable switching element, the trigger voltage in the case of a thyristor, to be supplied externally.

Using an externally controllable bypass configuration makes it possible to set up a diode laser configuration which contains additional diode laser bars or diode lasers which, in normal operation, are unused, i.e. are shorted by the bypass configuration. In the event of failure of a diode laser, this diode laser can be bridged and the unused diode laser can be switched in by opening the switching element associated with it, so that the diode laser configuration can continue to be operated using the same operating parameters and the same output power.

In another advantageous refinement of the invention, the bypass configuration is arranged between the contact and cooling plates of the diode laser; this allows simple integration of the bypass configuration into the stack.

The bypass element is advantageously cooled in the same way as the diode laser which is to be bridged is cooled.

In another advantageous embodiment, the bypass configuration and the diode laser are integrated on one chip. This reduces the production complexity for manufacturing a diode laser stack.

Other features which are considered as characteristic for the invention are set forth in the appended claims.

Although the invention is illustrated and described herein as embodied in a diode laser configuration with a plurality of diode lasers which are electrically connected in series, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram illustrating a diode laser configuration based on the invention;

FIG. 2 is a diagram of an exemplary embodiment of a bypass configuration;

FIG. 3 is a graph showing the current/voltage characteristic for a diode laser and for the bypass shown in FIGS. 2;

FIG. 4 is a diagram showing another advantageous exemplary embodiment of a self-switching bypass configuration; and

FIG. 5 is a basic illustration of the design of a diode laser configuration with a plurality of diode lasers that are electrically connected in series and are arranged on one another in a stack.

### DESCRIPTION OF THE PREFERRED EMBODIMENTS

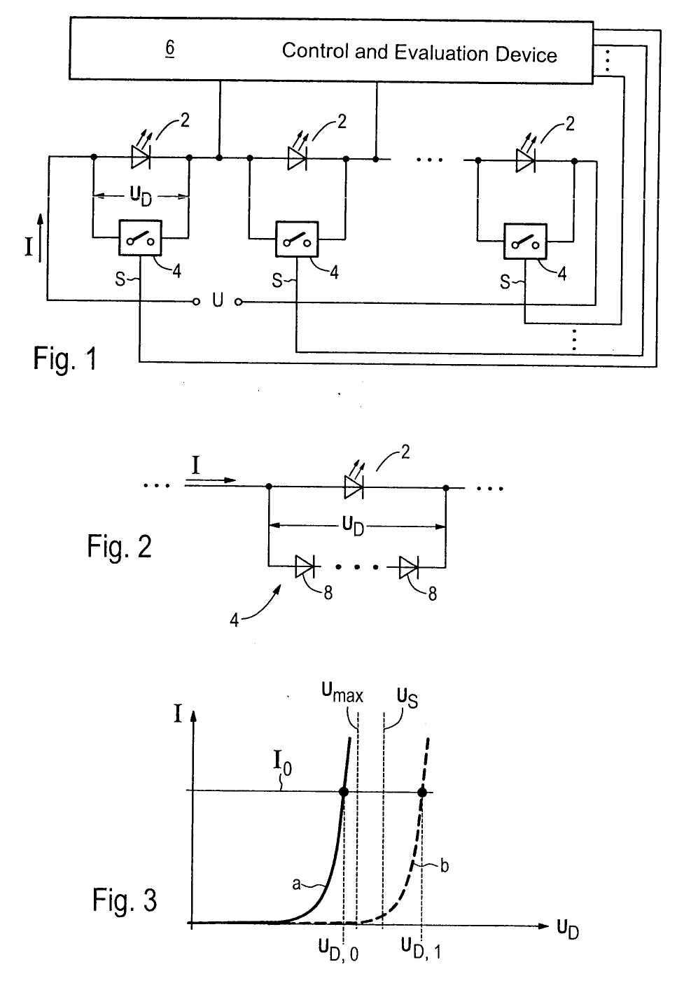

Referring now to the figures of the drawing in detail and first, particularly, to FIG. 1 thereof, there is shown a diode laser configuration based on the invention with a plurality of diode lasers 2 electrically connected in series to a voltage source U. The stack formed in this manner, which can contain up to several hundred diode lasers 2, has a large electrical current I flowing through it. The current I typically amounts to between 50 and 100 A. In normal operation, each diode laser 2 in this configuration has a voltage drop UD across it which is approximately 2 V, depending on the operating current and the diode laser design (e.g. wavelength). Each diode laser 2 has a bypass configuration 4 connected in parallel with it which, in normal operation (=not connected, illustrated symbolically by an open switch), has a high resistance, that is to say has a nonreactive resistance which is much higher than the nonreactive resistance of the diode laser 2 during normal operation thereof. The power loss consumption of the nonconnected bypass configuration is thus lower than the rated power consumption of the diode laser and is preferably less than 1/10 of the power consumption of the diode laser 2.

High-resistance failure of a single diode laser 2 results in an interruption in the diode laser circuit, which means that, without a bypass configuration 4, the total operating voltage U would be present across the diode laser 2 which had failed. In such a case, the diode laser 2 in question is provided with a low-resistance bridge by its associated bypass configuration 4 (the bypass configuration is switched in), so that the flow of current through the other diode lasers 2 is maintained at a virtually unaltered level. In this context, the term “low resistance” is to be understood to mean a resistance value which does not significantly exceed the resistance which the diode laser 2 would have in normal operation. Bypass configurations 4 whose resistance is significantly lower when the diode laser 2 fails than the resistance of the diode laser in normal operation are particularly advantageous.

A suitable bypass configuration 4 is basically any electrical circuit that performs the function of a controllable switch, i.e. contains a controllable switching element, for example a transistor or a thyristor. In this case, the control signal S required for control can be generated externally by a control and evaluation device 6 which monitors the voltage drop UD that is respectively present across the diode laser 2 and identifies the diode laser 2 which has failed or the diode lasers 2 which have failed. In principle, however, it is also possible to monitor the correct operation of the respective diode laser 2 within the bypass configuration 4 as well, i.e. the control signal S required for controlling the controllable switching element is not generated externally but rather internally in the bypass configuration 4. In this case, the bypass configuration 4 is self-switching.

Using an externally controllable bypass configuration 4, it is possible to short some of the diode lasers 2 directly in order to switch in an appropriate number of these shorted diode lasers 2 in the event of failure of one or more diode lasers 2 by opening the bypass configuration 4.

Referring now to FIG. 2, the bypass configuration 4 may be a circuit comprising a plurality of diodes 8. This circuit is a self-switching bypass configuration 4 which comprises passive (i.e., non-controlled) components and changes to low resistance without active provision of an external or internal control signal in the event of the diode laser itself changing to high resistance. The series circuit (shown in the figure) comprising the diodes 8 can be used to generate a current/voltage characteristic in a suitable manner, as FIG. 3 shows. This graph plots the current I flowing through the component formed from the diode laser 2 and the bypass configuration 4 connected in parallel therewith against the voltage U_{D}. Curve a shows the current/voltage characteristic of a diode laser which is intact and properly working. Curve b indicates the current/voltage characteristic of the bypass configuration 4, which comprises a series circuit containing diodes.

In this configuration, the bypass configuration 4 needs to have been proportioned such that its threshold voltage U_{S} is higher than the maximum operating voltage Uₘₐₓ of the diode laser. In other words, the bypass configuration 4 has a high resistance in the operating range of the diode laser 2 and changes to low resistance at voltages which exceed this operating range. As a result, only a negligible resistance loss is produced in the bypass configuration 4 in the operating range of the diode laser 2. In the exemplary embodiment, the differential resistance of the bypass configuration 4 has approximately the same magnitude in the event of the diode laser 2 failing. To maintain a constant flow of current I₀ through the stack, the voltage U_{D} across that component of the stack which comprises the faulty diode laser 2 and bypass configuration 4 needs to increase somewhat. In line with the relatively high potential difference U_{D,1}>U_{D,0} across the component, a somewhat higher power is converted for the same current I₀ in the component. If the laser output power of the diode laser configuration is regulated, the current I flowing through this diode laser configuration is additionally increased somewhat.

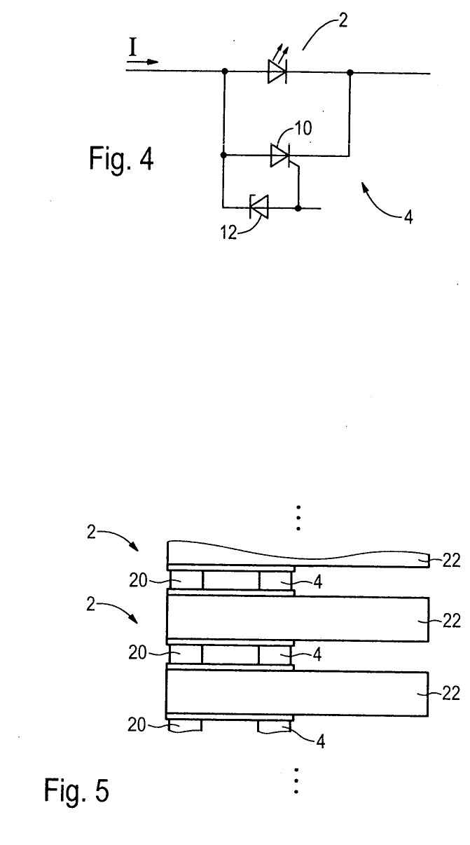

In the exemplary embodiment shown in FIG. 4, the bypass configuration 4 contains a thyristor 10 (p-type) which is electrically connected in parallel with the laser diode 2 and whose gate (control electrode) is connected to the anode of the diode laser 2 via a Zener diode 12. The Zener diode 12 prevents the thyristor 10 from being triggered in normal operation. If the voltage across the diode of the diode laser 2 rises as a result of a high-resistance fault and exceeds the Zener voltage of the Zener diode 12, a control current flows to the gate of the thyristor 10, which then triggers and bridges the laser diode 2. In this setup, the bypass configuration 4 is self-switching and the control electrode of the thyristor 10 is influenced directly (circuit design without the Zener diode) or indirectly via the anode voltage which is present across the laser diode 2. In principle, however, the gate of the thyristor 10 used as a controllable switch can also be switched using an external control voltage.

In line with FIG. 5, a plurality of diode lasers 2 which are electrically connected in series are arranged in a stack. In the exemplary embodiment, the diode lasers 2 arranged above one another form a vertical stack. Each diode laser 2 comprises a diode laser bar 20, which is situated between metal, preferably copper, contact plates 22 which simultaneously serve as heat sinks and additionally have microchannels, particularly in the power region, and are cooled by a cooling fluid. The diode laser bar 20 is soldered between the contact plates 22. Next to the diode laser bar 20, the bypass configuration 4 is soldered in between the contact plates 22 used as p-contacts and n-contacts in the design.

1. A diode laser configuration, comprising:
a plurality of diode lasers electrically connected in series, each of said diode lasers including a diode laser bar disposed on a cooling and contact element;
a plurality of bypass configurations each electrically connected in parallel with a respective said diode laser, said bypass configurations having a high resistance in normal operation and providing a low-resistance bridge for the respective said diode laser connected in parallel therewith in an event of a high-resistance fault in the respective said diode laser, said bypass configuration being commonly disposed on said cooling and contact element of the respective said diode laser connected in parallel therewith.

2. The diode laser configuration according to claim 1, wherein said bypass configuration is a self-switching bypass configuration.

3. The diode laser configuration according to claim 2, wherein said bypass configuration includes a diode with a high resistance at a voltage in the operating range of the diode laser.

4. The diode laser configuration according to claim 2, wherein said bypass configuration includes a combination of a plurality of diodes having a high resistance at a voltage in the operating range of the diode laser.

5. The diode laser configuration according to claim 2, wherein said bypass configuration includes a thyristor having a control electrode directly or indirectly influenced by an anode voltage applied to an anode of said diode laser.

6. The diode laser configuration according to claim 2, wherein said bypass configuration includes a combination of a plurality of thyristors each having a control electrode directly or indirectly influenced by an anode voltage applied to an anode of said diode laser.

7. The diode laser configuration according to claim 1, wherein said bypass configuration has an externally controllable switching element.

8. The diode laser configuration according to claim 1, wherein said bypass configuration is disposed between contact plates of said diode laser.

9. The diode laser configuration according to claim 1, wherein said bypass configuration and said diode laser are commonly integrated on one chip.

10. The diode laser configuration according to claim 1, wherein said bypass configuration and said diode laser are individual components.

11. A diode laser configuration, comprising:
a plurality of diode lasers electrically connected in series, each of said diode lasers including:
a cooling and contact element;
a diode laser bar disposed on said cooling and contact element;
a bypass configuration electrically connected in parallel with said diode laser bar and disposed on said cooling and contact element, said bypass configuration having a high resistance in normal operation and forming a low- resistance bridge for said diode laser bar in an event of a high-resistance fault in said diode laser bar.
